(19) United States
(12) Patent Application Publication
(10) Pub. No.: US 2014/0154395 A1
(43) Pub. Date: Jun. 5, 2014

(54) Crunchy egg product and manufacturing apparatus and process

(71) Applicant: Ray M. ALDEN, Raleigh, NC (US)

(72) Inventor: Ray M. ALDEN, Raleigh, NC (US)

(21) Appl. No.: 13/986,839

(22) Filed: Jun. 10, 2013

Related U.S. Application Data
(63) Continuation-in-part of application No. 13/573,242, filed on Sep. 4, 2012.

(51) Int. Cl. A23L 1/32

(52) U.S. Cl. CPC A23L 1/32
USPC 426/614

(57) ABSTRACT

The invention described herein comprises a crunchy egg product, manufacturing apparatus, and manufacturing processes to produce a desirable consumer product that is nutritious and fulfills a gap in crunchy low carbohydrate snack food product category. The final product comprises a high egg percentage by volume and a low water content by weight, audible fracturing characteristics, and brittleness characteristics. It comprises a low carbohydrate, high protein crunchy snack food for consumption by those on a low carbohydrate diet. Manufacturing steps and apparatuses are described.

### RELATED APPLICATIONS

This patent application is Continuation In Part of U.S. patent application Ser. No. 13/573,242 filed Sep. 4, 2012.

### BACKGROUND FIELD OF INVENTION

This invention relates to a food product manufactured for human or animal consumption. More specifically a crunchy, high protein, low carbohydrate product made primarily from eggs is described. The manufacturing apparatus and manufacturing process are also described.

### BACKGROUND

### Description of Prior Invention

Since before recorded history, humans have consumed eggs as a food. For thousands of years, eggs have been utilized as an important ingredient in thousands of food recipes. As an ingredient, eggs are often mixed into a batter with other ingredients. For example to make hundreds of types of baked goods, a grain such as wheat is used as a primary ingredient, eggs are mixed in to achieve properties such as cohesiveness, texture, and appearance while salt or sugar are added for taste. More recently United States Patent Application 2013/0022731, Olson disclosed a baked or fired food product that mixes a grain starch such as rice flour and egg to produce a snack food product.

In modern day western civilization, much cost and effort is expended by people trying to lose weight or to remain trim. One very common approach is to eat a diet significantly restricted in carbohydrates such as sugars, grains, starches, and grain flours. People on carbohydrate restricted diets typically substitute in more protein and fat than what is considered a traditional diet but these people can and do loose significant weight. Once a consumer starts a low carbohydrate diet, it quickly becomes apparent to them that few crunchy types of low carbohydrate snack foods are available in a conveniently packaged product.

Crunchy snack foods such as potato chips, corn chips, pretzels, crackers, and cookies all comprise high carbohydrates or sugars and low protein. Thus people whom are on carbohydrate restricted diets very much miss the possibility of snacking on crunchy snack foods. As described herein, a crunchy snack food made primarily from eggs and with no added grain starch or flour is a good substitute for crunchy snack foods made from carbohydrates such as grain flours, starches, and sugars.

### BRIEF SUMMARY

The present invention comprises the ingredients, apparatus, and manufacturing process required to manufacture a crunchy snack food that is low in carbohydrates and is high in protein. By weight the final crunchy egg product contains a protein to carbohydrate ratio as high as 9.76 parts protein to 1 part carbohydrate. Depending upon ingredient proportions, preparation, and cooking duration, the crunchy egg snack food described herein can take the form of a chip, a cracker, a cookie, a cereal, a puffed extrusion, a pasta, or other forms. The crunchy texture is described in terms of having a low water content, an audible “crack” sound when fractured, and a brittleness as demonstrated in fracture when subjected to even a low angular bend in a Three Point Bend test. During product consumption, the brittleness and sound comprise dimensions known to consumers as “crunchy”.

### Objects and Advantages

Accordingly, several objects and advantages of the present invention are apparent. The present invention utilizes eggs as a primary ingredient. The final product may comprise egg solids between 30% and 95% by weight. Eggs are a well known and accepted form of protein easily metabolized in the human body. Solids in the final product may comprise a protein to carbohydrate ratio between 1.49 to 1 and 9.76 to 1. Agricultural infrastructure makes eggs readily available in large quantities suitable as a high volume food source. Egg solids prepared and cooked as described herein form a low moisture crunchy product suitable for packaging and distribution as a long shelf life snack product. A large segment of the population is on a carbohydrate restricted diet and looking for products not containing sugar, flour, or starch ingredients while still having the attributes of common snack foods including crunchy texture, fracturing brittleness, fracturing sound, product cohesiveness, familiar mouth feel breakdown during chewing, customary tastes such as salt, cheese, and onion and hand or mouth sized dimensions suitable for eating with silverware or with one hand while driving or on the sofa without any fuss or mess. Also an optimal product includes no sugars, grain, grain flours, or starch.

Further objects and advantages will become apparent from the enclosed figures and specifications.

### DRAWING FIGURES

FIG. 1a illustrates a microwavable cookware dish.

FIG. 1b illustrates an oiling the cookware step.

FIG. 1c illustrates a deposition of raw egg batter step.

FIG. 1d illustrates a cooking step.

FIG. 1e illustrates a flat crunchy chip product.

FIG. 1f illustrates an alternate cooking step.

FIG. 1g illustrates a curled crunchy chip product.

FIG. 2a is an image of crispy egg white from batter XZ1 at 60× magnification.

FIG. 2b is an image of crispy egg white from batter XZ1 at 200× magnification

FIG. 3a is an image of crispy egg chip from gentle mixed batter at 60× magnification.

FIG. 3b is an image of crispy egg chip from gentle mixed batter at 200× magnification

FIG. 4 illustrates puzzle shaped crunchy treats.

FIG. 5 illustrates partially prepared chips and packaging.

FIG. 6a illustrates solidified cooked egg state in a crushing test.

FIG. 6b illustrate a crunchy cooked egg state in a three point bend test.

FIG. 6c illustrates a tough and chewy cooked egg state in a three point bend test.

FIG. 7 illustrates a crunchy egg based cereal product.

FIG. 8a illustrates first crunchy egg layered chip.

FIG. 8b illustrates second crunchy egg layered chip.

FIG. 8c illustrates third crunchy egg layered chip.

FIG. 8d illustrates a pretzel shaped mold.

FIG. 8e illustrates a layered pretzel shaped egg chip.

FIG. 8f is a top vie of the layered pretzel shaped egg chip.

FIG. 9 is an image of light passing through a translucent egg chip.

### DETAILED DESCRIPTION OF THE INVENTION

This patent application is a Continuation In Part of U.S. application Ser. No. 13/573,242 filed Sep. 4, 2012 which is incorporated in full herein by reference (but not reprinted herein to avoid redundancy).

### Crunchy Egg Chip Product Embodiment

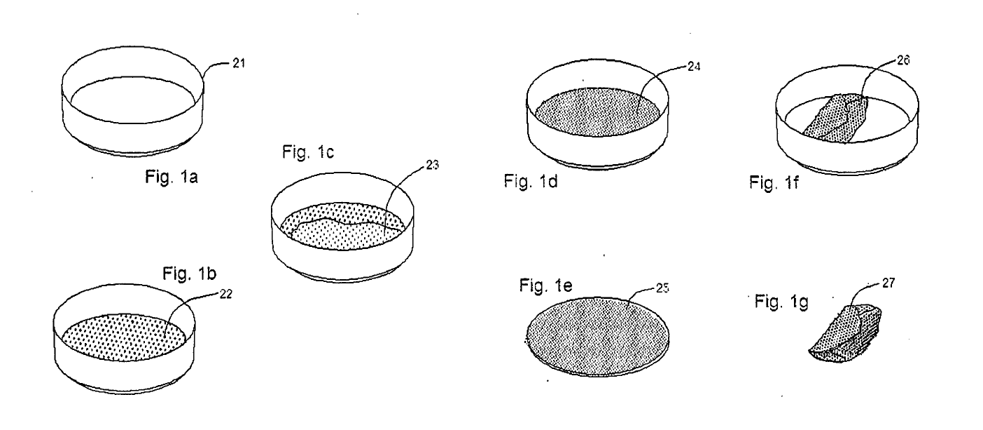

FIG. 1a illustrates a microwavable cookware dish 21 which is 3.5 inches in diameter, with a round shaped wall surrounding a flat bottom. The wall surrounding a flat bottom comprises a depression or mold into which ingredients such as oil and raw egg batter are deposited as described herein. As discussed herein, cooking steps are achieved using a microwave oven. During the cooking processes described herein, four dishes such as that in FIG. 1a, each containing batter, are put into the microwave at a time and cooked together as a batch.

FIG. 1b illustrates an oiling the cookware step. Oil on dish 22 is canola oil spray which is applied to cover the bottom and wall of the dish. Other oils work equally well.

FIG. 1c illustrates a deposition of raw egg batter step. Batter in dish 23 comprises at least one egg ingredient which is first mixed in the proportions described herein and then deposited into the oiled dish. Dried egg white is a preferred ingredient but any liquid egg or powdered egg can be utilized. The term “raw” herein means egg that is not in a solidified state (the moist solid mass commonly known as a cooked egg).

FIG. 1d illustrates a cooking step. Cooking raw egg batter containing powdered or dried egg white in a microwave includes energy absorption and water absorption phenomena that contrast with frying raw egg batter and contrast with baking raw egg batter. Microwave energy excites water molecules and as those molecules are excited and rise in temperature, the powdered egg component competes to absorb the water molecules, during egg solidification and after egg solidification, expansion pressures exist within the solidifying/solidified mass, the egg mass physically moves around and expands dramatically. This effect is observed when cooking a batter such as Batter Z2A (below) that contains a significant portion of dried egg but no gelatin relaxant. The expansion and movement effect is utilized in the present invention wherein a small volume of raw egg batter (such as 0.5 teaspoon) that is a randomly shaped deposition within the dish depression not even covering the dish's bottom, then during the solidification process it expands to fill its container shape and than retains that shape as a solid round mass. Thus the desired shape of a round chip is achieved due to the expansive nature of transforming raw egg to solidified egg in the microwave oven. Other forms of cooking may not invoke this same behavior in the egg. The chip shape is technically three dimensional but its height dimension is very thin relative to its length and width dimensions. The egg expansion during the microwave cooking step can be utilized to form a three dimensional product that has a larger relative height dimension than does a chip product. Once water is absorbed internally by the egg and once the water component is significantly diminished, the egg mass stops visibly moving as it continues to receive microwave energy. Thus the cooking solidification step of transforming a raw egg batter into a solid egg mass is completed in the microwave oven.

Once the mass stops moving the remainder of microwave energy drives moisture content out of the mass to crisp. It should be noted that during microwaving, the temperature of the dish becomes elevated to around the boiling point of water (give or take tens of degrees) during cooking. And then becomes more elevated as the water diminishes. The temperature of the dish contributes to the overall cooking, drying, crisping, and browning of the product.

To achieve the cooking crisping step (transformation of the solidified egg into a crunchy egg product), the cooking dish continues to cook in the microwave. As discussed herein, when heated and/or infused with microwave energy, egg transforms from a raw state (batter), then to a solidified state (cooked egg), then to a crisped state (crunchy egg product). Below is a discussion of how these states are differentiated and also how a tough chewy state that exists between solidification and crisping differs from the solid state and from the crunchy state.

If the product emerges from this process with crunchy portions and chewy portions, it can be further dried by sitting in dry air or in a heated dryer wherein the chewy portions will transform to a crunchy consistency throughout. An expanded solidified chip 24 takes up the bottom of its cooking bowl, when containing gelatin as a relaxant or when cooked on 50% power, it will be round with little or no raised edges.

FIG. 1e illustrates a flat crunchy egg chip 25 product. When Batter Z5A described below is utilized, the cooking process described above results in a flat round crunchy chip product that is ready for packaging, shipping, sales, and consumption.

The crunchy egg chip product has a delicious flavor, familiar chip mouth feel, is very crunchy, is tan colored, and has a uniform smooth surface. The flat chip of FIG. 1e is a contrast with the chip described in FIGS. 1F, and 1g. In FIG. 1e, gelatin serves as a relaxing agent that is thought to compete with the powdered egg for water during heating. Also during heating, powdered egg may absorb gelatin instead of water. Observing chips under the microscope reveals a solid consistency, in some cases with materials combining as composites of different materials and in some case with materials combining as a singular material. In any case, whereas the batter with gelatin in FIGS. 1d and 1e remains flat during cooking and results in the flat chip (and does not undergo the amount of movement described above), the batter Z2A without gelatin goes through much movement during microwave heating (as described above) comprising a solid moving mass during cooking 26 and produces a curled chip 27 product of FIG. 1g.

FIG. 1f illustrates an alternate cooking step. Batter Z2A below, is mixed and placed into the dish. From the time when the batter begins transforming to the solidified state until the time when it becomes significantly moisture reduced, the egg first expands horizontally to be a circular disk on the bottom of the dish, then as heating continues, its edges start lifting off the surface of the dish, eventually some portion of the edges flip and contact a more inner portion of the egg and get stuck there creating the curled chip instead of a flat chip. As heating continues the egg becomes a rigid brittle chip of FIG. 1g.

FIG. 1g illustrates a curled crunchy chip product. The curled shape results from edges of the chip curling during microwave heating and then the shape is made rigid as the chip further cooks. Batter, such as Z2A, that contains dried egg white but no gelatin tends to curl in a microwave when cooked as describe below at full power. Cooking for a longer duration at 50% microwave power reduces the curling effect.

Following are recipes, processes and results produced therefrom. Many combinations of ingredients where used and cooked in a variety of process steps to produce a product with suitable crunchy characteristics, egg content, protein to carbohydrate ratio, taste, color, and mouth feel. Examples described herein include multiple ingredient combinations such as liquid egg white, dried egg white, water, oil, gelatin, and/or dried butter milk. The following suppliers ingredients were used in the below examples; All Whites 100% liquid egg whites, Deb El 100% dried egg whites, Food Lion spray canola oil, SACO powdered Cultured Butter Milk, Carnation to Instant Milk, and Knox unflavored Gelatine. (Dried milk and dried butter milk are interchangeable in all recipes.)

Half a teaspoon of Batter XZ1 was placed in each of 4 dishes in a batch of oiled dishes which were then cooked in the microwave for the duration described, the result comprised a crunchy product, reasonably tasty, similar to a pork rind. It was shaped like a very thin and tiny inverted tea cup. Products produced from batter XZ1 contained the following components by weight; egg between 70% to 96%, water between 2% and 15%, and canola oil between 2% and 15%. The results achieved with Batter XZ1 with a pure liquid egg white batter illustrate how the microwave process herein produces advantages compared to cooking processes reliant entirely on baking and/or frying. Olson et al explicitly specifies that the cooking processes utilized therein failed to convert a batter of only liquid egg white to a crunchy egg product. Microwaving being a cooking process that explicitly does convert a batter of only liquid egg white to a crunchy egg product. Success with these ingredients and others described herein contrasts with Olson et al “Example 1” paragraph [0057] which states that pure egg white when baked and then fried according to Olson's processes did not produce a crispy texture when cooked in the prescribed manner. Similarly, Olson “Example 2” paragraph [0058] states that egg and water did not produce a crispy texture when cooked according to the Olson processes.

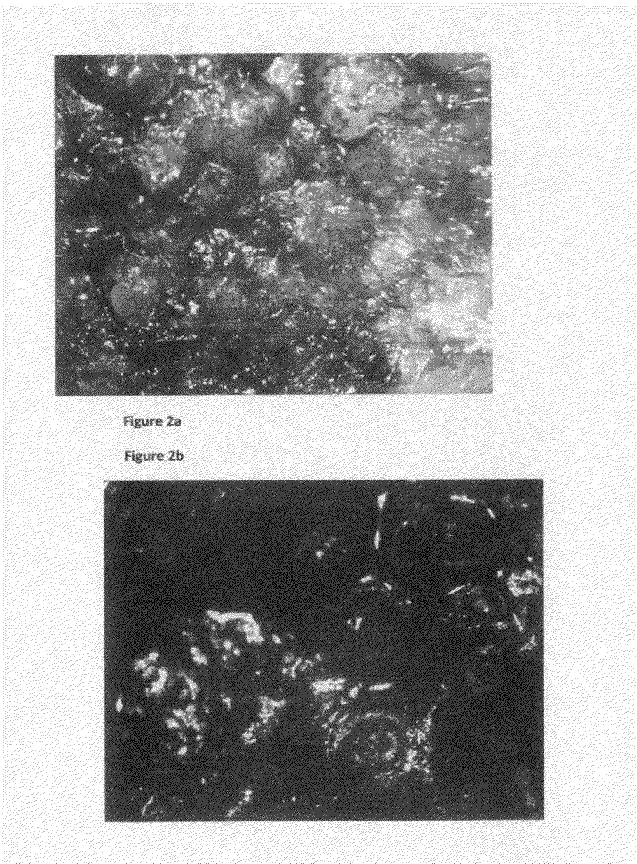

Herein, FIG. 2a is an image of crispy egg white from batter XZ1 at 60× magnification. A crystal like structure is observed, several holes can be seen under magnification but it is not characterized as being porous. FIG. 2b is an image of crispy egg white from batter XZ1 at 200× magnification. The smooth nature of the cooked crunchy egg white is observed.

| | | |
|---|---|---|
| Batter XZ1 | egg white | 2 teaspoon |
| Dish | canola oil | sprayed canola |
| | add batter | .5 teaspoon |
| Cook | Microwave | 3 minutes |
| Results | Color | varied, white, golden, dark brown |
| | Solid | yes |
| | Crunchy | yes |
| | Mouth feel | crunchy, like a pork rind |
| | taste | good, like a pork rind |

Batter Z1A was placed as a batch in the microwave and cooked as described. Half a teaspoon of canola oil was placed in each dish. One teaspoon of Batter Z1A was placed in the oil within the dish and cooked in the microwave for the duration described, the result comprised a crunchy attribute as it is crushed between the teeth but also a chewy sensation and an okay taste. Products produced from batter Z1A contained on average the following components by weight; egg 40%, water between 10% and canola oil 50%. If the product is allowed to sit in dried air after microwaving, the chewy aspect is reduced.

| | | |
|---|---|---|
| Batter Z1A | egg white | 4 teaspoon |
| Dish | canola oil | .5 teaspoon |
| | add batter | 1 teaspoon |
| Cook | Microwave | 2.25 minutes |
| Results | Color | varied, golden, dark specs |
| | Solid | yes |
| | Crunchy | yes |
| | Mouth feel | chrunchy and chewy |
| | taste | okay |

Batter X1A was placed as a batch in the microwave and cooked as described. This did transform into a crunchy egg product but did not comprise a highly favored taste or mouth feel. Products produced from batter X1A contained on average the following components by weight; egg 30%, water 10% and canola oil 60%.

| | | |
|---|---|---|
| Batter X1A | egg white | 4 teaspoon |
| | Canola Oil | 2 teaspoons |
| Dish | canola oil | sprayed |
| | add batter | 1 teaspoon |
| Cook | Microwave | 2.25 minutes |
| Results | Color | golden |
| | Solid | yes |
| | Crunchy | yes |
| | Mouth feel | flaky |
| | taste | not good |

Batter Z2A was placed as a batch in the microwave and cooked as described. This did transform into a crunchy egg product but did not comprise a highly favored taste or mouth feel. Products produced from batter Z2A contained on average the following components by weight; egg 75%, water 15% and canola oil 10%.

| | | |
|---|---|---|
| Batter Z2A | egg white | 4 teaspoon |
| | dried egg white | 2 teaspoon |
| Dish | oiled | sprayed canola |
| | add batter | 1 teaspoon |
| Cook | Microwave | 2.25 minutes |
| Results | Color | white |
| | Solid | yes-curled |
| | Crunchy | yes |
| | Mouth feel | not good, flaky, mushy after effect’ |
| | taste | not good, dry |

Batter Z3A was placed as a batch in the microwave and cooked as described. When cooked longer than described, this mixture does fully transform into a crunchy egg product but did not comprise a highly favored taste or mouth feel. Products produced from batter Z3A contained on average the following components by weight; egg 40%, water 10% and canola oil 50%.

| | | |
|---|---|---|
| Batter Z3A | egg white | 2 teaspoon |
| | dried egg white | 2 teaspoon |
| | canola oil | 2 teaspoon |
| Dish | oiled | sprayed canola |
| | add batter | 1 teaspoon |
| Cook | Microwave | 2.25 minutes |
| Results | Color | golden |
| | Solid | yes |
| | Crunchy | crunchy and chewy |
| | Mouth feel | flakey |
| | taste | not good |

Batter Z4A was placed as a batch in the microwave and cooked as described. This did transform into a crunchy egg product that had a reasonably good taste and mouth feel. Products produced from batter Z4A contained on average the following components by weight; egg 30%, milk 30%, water 10% and canola oil 30%.

| | | |
|---|---|---|
| Batter Z4A | water | 4 teaspoon |
| | dried egg white | 2 teaspoon |
| | dried milk | 2 teaspoon |
| | canola oil | 1 teaspoon |
| | salt | to taste |
| Dish | oiled | sprayed canola |
| | add batter | 1 teaspoon |
| Cook | Microwave | 2 minutes |
| Results | Color | golden |
| | Solid | yes, curls |
| | Crunchy | yes |
| | Mouth feel | okay |
| | taste | good |

Batter Z5A was placed as a batch in the microwave and cooked as described. The resulting product was a flat round consistent chip, nice in appearance, flavorful and fun to eat. Products produced from batter Z5A contained on average the following components by weight; egg 40%, gelatin 10%, water 15% and canola oil 35%.

| | | |
|---|---|---|
| Batter Z5A | water | 4 teaspoon |
| | dried egg white | 2 teaspoon |
| | gelatin (unflavored) | .5 teaspoon |
| | canola oil | 1 teaspoon |
| | salt | to taste |
| Dish | oiled | sprayed canola |
| | add batter | 1 teaspoon |
| Cook | Microwave | 2 minutes |
| Results | Color | golden |
| | Solid | yes, flat chip |
| | Crunchy | yes |
| | Mouth feel | good |
| | taste | delicious |

Batter Z6A was placed as a batch in the microwave and cooked as described. Products produced from batter Z6A contained on average the following components by weight; egg 40%, milk 20%, gelatin 10%, water 10% and canola oil 20%.

| | | |
|---|---|---|
| Batter Z6A | water | 6 teaspoons |
| | dried egg white | 2 teaspoon |
| | dried milk | 1 teaspoon |
| | gelatin (unflavored) | .5 teaspoon |
| | canola oil | 1 teaspoon |
| | salt | to taste |
| Dish | oiled | sprayed canola |
| | add batter | .5 teaspoon |
| Cook | Microwave | 2 minutes |
| Results | Color | golden |
| | Solid | yes |
| | Crunchy | yes |
| | Mouth feel | good |
| | taste | delicious |

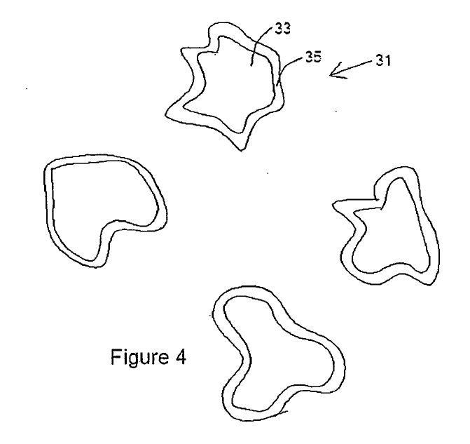

Batter X2A was placed as a batch in the microwave and cooked as described. Products produced from batter X2A contained on average the following components by weight; egg 45%, milk 20%, water 10% and canola oil 25%. This product did not expand to fill the dish but instead maintained puzzle piece shapes with a elevated ridge around the perimeter. The crunch component of this product was exceptional. FIG. 4 illustrates puzzle shaped crunchy treats that resulted as a crunchy buttermilk egg chip 31 that included a flat center region 33, and a raised edge region 35. This product is a great chip and also suitable to produce in a smaller size to be consumed with milk in a bowl as cereal.

| | | |
|---|---|---|
| Batter X2A | liquid egg white | 2 tablespoons |
| | dried egg white | 2 teaspoon |
| | dried butter milk | 1 teaspoon |
| Dish | oiled | .5 teaspoon in dish |
| | add batter | .5 teaspoon |
| Cook | Microwave | 2 minutes |
| Results | Color | golden |
| | Solid | yes |
| | Crunchy | yes |
| | Mouth feel | good |
| | taste | delicious |

Batter X3A was placed as a batch in the microwave and cooked as described. Products produced from batter X3A contained on average the following components by weight; egg 50%, gelatin 15%, water 10% and canola oil 25%.

| | | |
|---|---|---|
| Batter X3A | liquid egg white | 2 tablespoons |
| | dried egg white | 2 teaspoon |
| | gelatin (unflavored) | .5 teaspoon |
| Dish | oiled | .5 teaspoon in dish |
| | add batter | .5 teaspoon |
| Cook | Microwave | 2 minutes |
| Results | Color | golden |
| | Solid | yes |
| | Crunchy | yes |
| | Mouth feel | good |
| | taste | delicious |

Batter Z7A was placed as a batch in the microwave and cooked as described. Products produced from batter Z7A contained on average the following components by weight; egg 40%, milk 20%, gelatin 10%, water 10% and canola oil 20%. This batter and process consistently produced round crunchy egg chips that were enjoyed. Increasing gelatin content twice or more increases hardness of the chip. This combination of ingredients can hold two times or more oil than described. Increasing the oil increases flavor and mouth feel but reduces the percentages of other ingredients.

| | | |
|---|---|---|
| Batter Z7A | liquid egg white | 6 teaspoons |
| | dried egg white | 2 teaspoon |
| | dried butter milk | 1 teaspoon |
| | gelatin (unflavored) | .5 teaspoon |
| | canola oil | 1 teaspoon |
| Dish | oiled | sprayed canola |
| | add batter | .5 teaspoon |
| Cook | Microwave | 2 minutes |
| Results | Color | golden |
| | Solid | yes |
| | Crunchy | yes |
| | Mouth feel | good |
| | taste | delicious |

Experimentation reveals that using a microwave electromagnetic energy cooking process, many combinations of ingredients produce crunchy egg products. In fact liquid egg whites alone (egg whites are equivalent to a mixture of 13% powdered egg whites plus 87% water) cooked in the microwave produces a crunchy egg product. Our cooking process produces tasty crunchy egg products containing a high egg percentage as high as 96% and a low carbohydrate to protein ratio as discussed below. In particular each combination using egg whites alone, or egg whites plus gelatin, or egg whites plus dried buttermilk, or egg whites plus gelatin and dried milk produces a crunchy chip with nice taste, mouth feel, and pleasing visual attributes. Each combination also using some form of oil either to lubricate the dish, or to be a shallow bath into which the batter is placed, or to be mixed into the batter before placement within the dish.

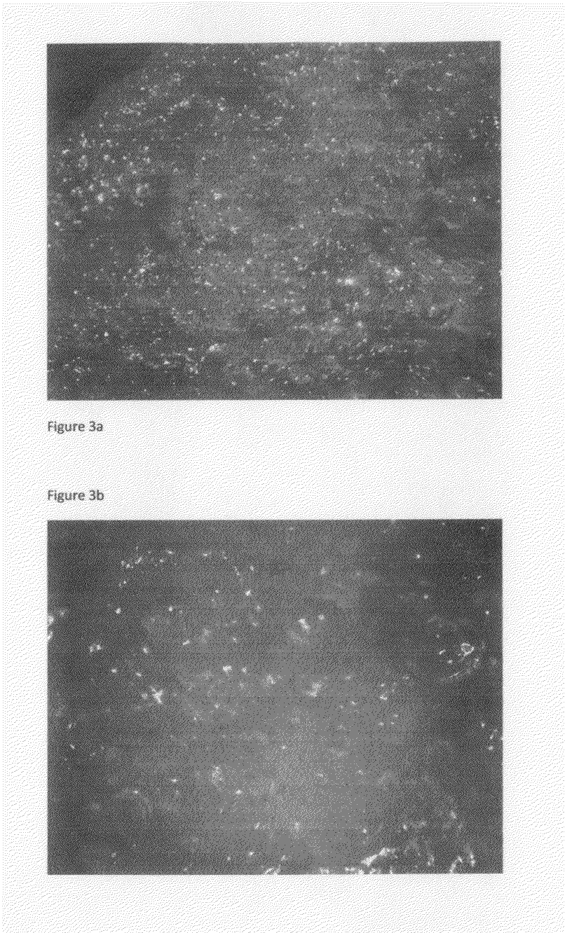

Porosity of the products produced are a function of the mixing methodology. Batter that was stirred vigorously where air was mixed into the batter had a wide range of pore sizes throughout the final product. This porosity being visible without magnification and also under a microscope. Mixing processes that minimized air introduction produced no porosity. For example one teaspoon of canola oil was placed in a cup sized mixing bowl. Two teaspoons powdered egg was added and gently stirred until the egg melted into the oil. Five teaspoons of liquid egg white was added along with one teaspoon of gelatin, and one teaspoon of dried butter milk. This mixture was gently stirred until consistent. Half a teaspoon was placed in a oiled dish and a batch of four such dishes were microwaved for 2 minutes. The resulting product was a crunchy thick chip varying in color from white to tan to brown. At zero magnification, 10× magnification, 60× magnification, and 200× magnification the product is not porous. Instead, when illuminated from above and below it is a pock marked rigid substrate resembling the surface of the moon. Under magnification it is a sealed material with a shimmering light reflective look. There are pockets resembling pores but instead of being porous voids they are filled with materials. FIG. 3a is an image of a crispy egg chip from gentle mixed batter at 60× to magnification, it is not porous. FIG. 3b is an image of crispy egg chip from gentle mixed batter at 200× magnification, it is not porous.

### Protein Density of the Present Invention Compared to the Prior Art.

The results achieved by the present invention offer distinct advantages over those described in the prior art. The following table lists the products that were described by Olson et al. Only those products that resulted in a crispy texture are included herein. Ingredients for each product are included and used to calculate a relationship of protein units per carbohydrate units. The higher the number in the right most column, the better for those consumers on a high protein low carbohydrate diet. Virtually all of the non-egg ingredients utilized by Olson to achieve a crispy product are high in carbohydrate percentage and low in protein percentage. The Olson invention produces a product between 0.55 to 1 and 1.92 to 1 protein units to carbohydrate units.

| | | | | | | | | | | | | protein |
|---|---|---|---|---|---|---|---|---|---|---|---|---|
| | | dried | | | | | | | | | | units |
| | liquid | egg | dried | | | sweet | | | | | | per |
| | egg | white | egg | xanthan | tapioca | rice | wheat | rice | | Carb. | protein | carb |
| | white | (calc.) | white | gum | starch | flour | flour | flour | Units | Density | density | unit |
| Carbohydrate % | | 0.10 | 0.10 | 0.81 | 0.89 | 0.80 | 0.76 | 0.80 | | | | |
| Protein % | | 0.75 | 0.75 | 0.06 | 0.01 | 0.07 | 0.10 | 0.06 | | | | |
| Olson/pp0065 | 159.40 | 20.72 | 0.00 | 0.12 | 1.32 | 6.21 | 0.00 | 0.00 | 28.37 | 0.29 | 0.56 | 1.92 |
| Olson/pp0069 | 76.00 | 9.88 | 0.00 | 0.20 | 1.00 | 0.00 | 0.00 | 16.60 | 27.68 | 0.55 | 0.30 | 0.55 |
| Olson/pp0071 | 76.00 | 9.88 | 0.00 | 0.20 | 1.00 | 0.00 | 0.00 | 16.60 | 27.68 | 0.55 | 0.30 | 0.55 |
| Olson/pp0073 | 0.00 | 0.00 | 15.00 | 0.20 | 1.00 | 0.00 | 0.00 | 16.80 | 33.00 | 0.48 | 0.37 | 0.77 |
| Olson/pp0075 | 0.00 | 0.00 | 15.00 | 0.20 | 0.00 | 0.00 | 0.00 | 16.80 | 32.00 | 0.47 | 0.38 | 0.81 |
| Olson/pp0077 | 0.00 | 0.00 | 15.00 | 0.20 | 0.00 | 0.00 | 16.80 | 0.00 | 32.00 | 0.45 | 0.40 | 0.90 |

By contrast, the non-egg ingredients that produce a crunchy egg product in the present invention are all high in protein and low in carbohydrates. The present ingredients produce a product between 1.45 to 1 and 9.76 to 1 protein units to carbohydrate units.

| | liquid | powdered | powdered | | | | | | protein |
|---|---|---|---|---|---|---|---|---|---|
| | egg | egg white | egg white | dried | | | Carb. | protein | units per |
| | white | (calculated) | (actual) | milk | gelatin | Units | Density | density | carb unit |
| Carbohydrate % | | 0.10 | 0.10 | 0.57 | 0.01 | | | | |
| Protein % | | 0.75 | 0.75 | 0.25 | 1.00 | | | | |
| Alden/XZ1 | 2.00 | 0.26 | 0.00 | 0.00 | 0.00 | 0.26 | 0.10 | 0.75 | 7.50 |
| Alden/Z4A | 0.00 | 0.00 | 2.00 | 2.00 | 0.00 | 4.00 | 0.34 | 0.50 | 1.49 |
| Alden/Z5A | 0.00 | 0.00 | 2.00 | 0.00 | 0.50 | 2.50 | 0.08 | 0.80 | 9.76 |
| Alden/Z6A | 0.00 | 0.00 | 2.00 | 1.00 | 0.50 | 3.50 | 0.22 | 0.64 | 2.90 |
| Alden/X2A | 2.00 | 0.26 | 2.00 | 1.00 | 0.00 | 3.26 | 0.24 | 0.60 | 2.44 |
| Alden/X3A | 2.00 | 0.26 | 2.00 | 0.00 | 0.50 | 2.76 | 0.08 | 0.80 | 9.50 |
| Alden/Z7A | 6.00 | 0.78 | 2.00 | 1.00 | 0.50 | 4.28 | 0.20 | 0.66 | 3.32 |

For the preceding two tables, where liquid egg whites were used, the equivalent amount of dried egg whites was calculated for consistent comparison. Also for the preceding two tables, oil content has not been included in the comparison tables because the oil content can be increased or decreased in each recipe to achieve a balance of characteristics including desired flavor, desired mouth feel, and desired fat from oil. Each approach will include a range of similar oil components.
The following two tables describe the range of ingredients by weight in a one ounce bag of egg chips achieved using batter Z7A.

| | Ounces in |
|---|---|
| Ingredient | 1 oz bag |
| dried egg white | 0.46 |
| canola oil | 0.15 |
| dried butter milk | 0.15 |
| unflavored gelatin | 0.08 |
| water | 0.15 |
| TOTAL Bag Weight | 1.00 |

| | Ounces in |
|---|---|
| Ingredient | 1 oz bag |
| dried egg white | 0.54 |
| canola oil | 0.15 |
| dried butter milk | 0.18 |
| unflavored gelatin | 0.11 |
| water | 0.02 |
| TOTAL Bag Weight | 1.00 |

### Crunchy Egg Chip for Home or Restaurant Embodiment

Partially prepared food is commonly purchased for restaurant use and for home use. For example restaurants and consumers often buy frozen french-fries that have been factory prepared to a partially ready state then purchased. The remaining cooking steps are done at the restaurant or at home. For example after purchase, the frozen french-fries are taken from a frozen bag, placed in the oven or in a fryer, and cooked, then salted and served.

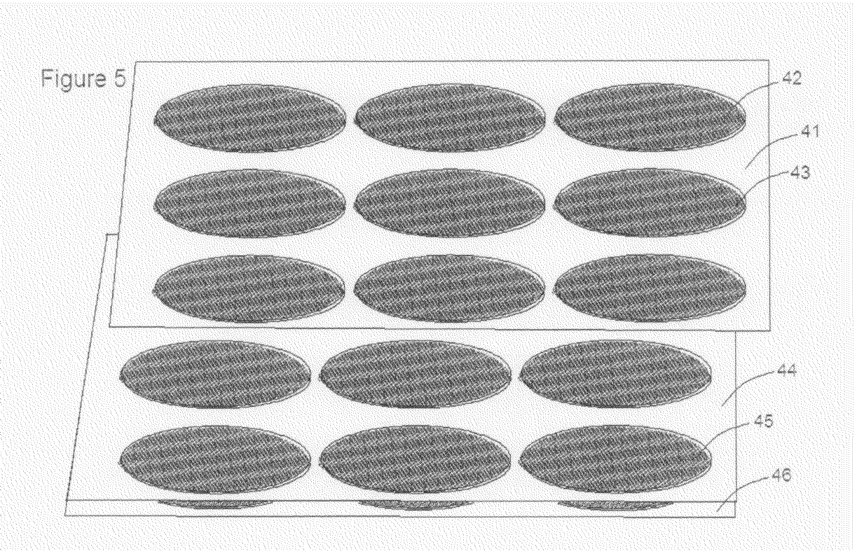

Similarly crunchy egg products can be manufactured to a partially ready state, packaged, sold to a customer, and then fully cooked by the customer. The above ingredients are prepared and cooked to the solidified egg step, then they are placed upon parchment paper, stacked in layers, bagged, and refrigerated or frozen for storage. The first cooking step at the manufacturer solidifies the egg batter into a solid mass comprising fully cooked egg that still has high moisture content, is flexible, not crunchy, is two to four mm thick and three inches in diameter. The bagged chips are then refrigerated or frozen, shipped, and sold as a partially prepared product. When it is time to prepare the chip product for consumption, the solidified chips need to be crisped. The chips are removed from the packaging and parchment paper, spread out on an oiled cookie sheet and baked to a crisp. Alternately they are spread out on an oiled dish and cooked in the microwave to a crisp. Alternately, they are placed in oil and fried to a crisp. FIG. 5 illustrates partially prepared chips and packaging. A first parchment sheet 41 has placed thereon, a first partially cooked chip 42 and a second partially cooked chip 43 along with a plurality of to chips. A second parchment sheet 44 has placed thereon a third partially cooked chip 45 along with a plurality of partially cooked chips. A third parchment sheet 46 has placed thereon a plurality of partially cooked chips. The parchment paper keeps the layers of chips from sticking together during refrigeration, freezing, and shipping so that they are easily separated for the final cooking step at home or at the restaurant.

### Crunchy Egg Cereal Embodiment

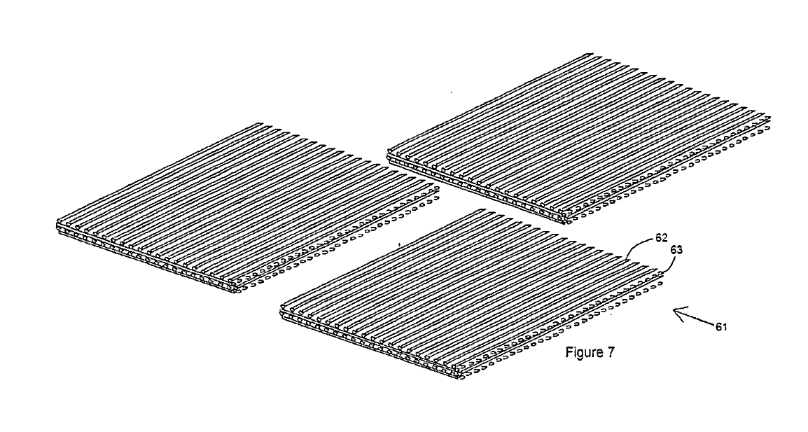

FIG. 7 illustrates a crunchy egg based cereal product. Four teaspoons of liquid egg white was added along with two teaspoons dried egg white, one teaspoon of gelatin, and one teaspoon of dried butter milk. This mixture was gently stirred until consistent. The mixture was placed in a bottle and extruded through a spaghetti sized hole onto an oiled dish to form a series of four inch long extrusion and which were then cooked for twenty seconds to a solidified consistently. Several such extrusions were produced, each was then cut into one inch lengths and then layered together to form a Cereal wafer 61 which was then microwaved for thirty seconds to a crisp consistency. The layers remained stuck together including a first layer of crunchy egg structures 62 and a second layer of crunchy egg structures 63. The final product was placed in milk and eaten like breakfast cereal. Its consistently is reminiscent of shredded wheat cereal but much higher in protein and lower in carbohydrates.

### Crunchy Egg Cookie Embodiment

Crunchy egg cookies were produced using the above recipes with addition of an artificial sweetener. For example one teaspoon of canola oil, two teaspoons powdered egg, five teaspoons of liquid egg white, one teaspoon of gelatin, one teaspoon of dried butter milk, and half a teaspoon of Splenda were mixed until consistent. Half a teaspoon was placed in a oiled dish and a batch of four such dishes were microwaved for 2 minutes. The resulting product was a crunchy sweet cookie ¼ inch thick varying in color from white to tan to brown.

To an identical batch was added a teaspoon of semi sweet chocolate bits. This mixture was cooked in a microwave for ninety seconds. The result was a wonderfully soft and moist chocolate chip cookie. If allowed to sit for 10 minutes, the cookie hardens and crisps up. This transition of the present invention's chocolate chip cookie from warm, moist, and soft just out of the oven to cool, harder, and brittle is very similarly to the transition a fresh baked flour based chocolate chip cookie goes through.

Adding less liquid egg white produces a thicker batter and a thicker cookie.

### Tough and Chewy Egg Jerky Product Embodiment

Beef jerky is well known in the prior art. It comprises a high protein snack that is tough, resists tearing, and is chewy when eaten. These properties are achieved by drying meat such that it is still flexible but has a reduced moisture content. Raw beef before drying may contain protein at a ratio of 7 g to 30 g. Drying removes 15 g of water leaving roughly 6 g of water and 7 g of protein per 15 g of dried meat. After drying, the beef jerky has a long shelf life when packed in a high oxygen barrier bag along with an oxygen absorbent pouch such as powdered iron or iron salts to prevent growth of aerobic microorganisms such as fungus. An egg based product having properties similar to beef jerky is described herein.

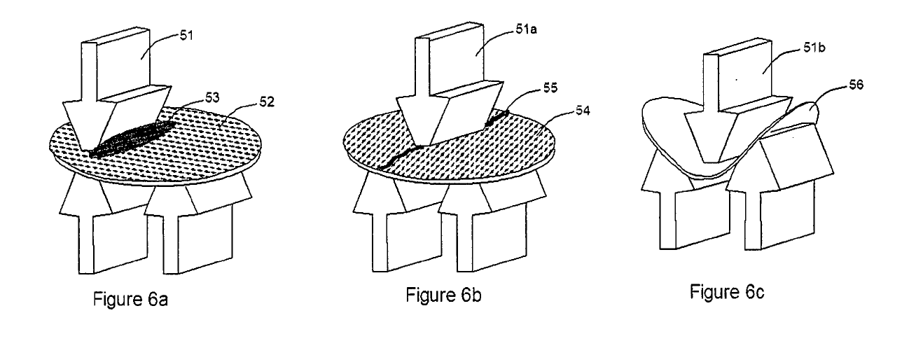

Traditional cooking of an egg comprises a transition from a liquid or “runny egg” state to a solid cooked egg state (a first cooked egg state) that still has high moisture content, is flexible, is not brittle, is not crunchy, will not fracture when subjected to small angular bends in a three point bend test, will not make an audible sound when fractured. The solid cooked state comprises a solid that is flexible and easily torn when subjected to a strength test. FIG. 6a illustrates solidified egg state in a crushing test. A first state descending test rod 51 descends to crush a solidified egg mass 52. The solidified egg mass when subjected to a crushing test is characterized by a squishy displacement 53 whereupon egg materials squishes away from the displacement. A similar phenomenon is observed when eating solidified egg, it is easily broken down by teeth with very little effort and the internal moisture allows transfer of pressure within and material displacement squishes away from teeth. This is a contrast from the other states of cooked eggs.

As previously discussed, a crunchy egg product (a second cooked egg state) is produced by transitioning egg from a solid cooked state to a low moisture crispy or crunchy egg state. The low moisture crispy state comprises a brittle solid that fractures when subjected to low angular to stress in a three point bend test producing an audible sound. FIG. 6b illustrate a crunchy egg state in a three point bend test. A second state descending test rod 51a descends to put mechanical pressure on the midpoint of a crunchy egg chip 54. After withstanding some pressure and yielding little angular bend, the crunchy egg chip breaks at a second state fracture 55 which breaks the chip into two pieces. This second cooked egg state is characterized by fracturing with little angular flex and producing an audible sound upon fracture. This property is a contrast with the other two cooked egg states.

A third cooked egg state, that of tough and chewy, exists between the solid cooked egg state and the crispy egg state. To achieve the tough chewy egg state, cooking is interrupted midway through the crisping process. The result is a low moisture, flexible, non-brittle, tough, and chewy product. The product is difficult to bite through, tear, and once bitten off requires prolonged chewing to be mechanically broken down into a small particle constituency before being swallowed. FIG. 6c illustrates a tough and chewy state in a three point bend test. A third state descending test rod 51b descends to put mechanical pressure on the midpoint of a tough chewy egg product 56. The product lacks the moisture to transfer mechanical energy to enable a material flow or squish away from the pressure and lacks the rigidness to transfer mechanical energy internally as a crack thus it differs from the first cooked egg state and the second cooked egg state. Instead the third cooked egg state folds and compresses under pressure to the point where a breach eventually occurs under more pressure with the material folding away from the breach. The third cooked egg state is neither squishy like the first cooked egg state nor brittle like the second cooked egg state.

For example one teaspoon of canola oil was placed in a cup sized mixing bowl. Two teaspoons powdered egg was added and stirred until the egg melted into the oil. Four teaspoons of liquid egg white was added along with two teaspoons of gelatin This mixture was gently stirred until consistent. Half a teaspoon was placed in a oiled dish and a batch of four such dishes were microwaved for 1 minutes. The resulting product was a flexible tough and chewy product off white in color, this is the third state of cooked eggs.

Comparison and differentiation of the three states of cooked eggs. When teeth such as to molars bear down upon solidified egg (the first cooked state of eggs), the molars easily pass through the solidified egg thereby mechanically breaking the solidified egg into smaller constituent parts. When teeth such as molars bear down upon crunchy egg (the second cooked state of eggs), the molars easily crush the crispy egg whereby the mechanical process fractures and crumbles crispy egg into smaller constituent parts. By contrast, when teeth such as molars bear down upon the tough and chewy egg (the third cooked state of eggs), the molars cannot easily pass through or crush the tough chewy egg. Also the teeth do not cause a mechanical fracturing of the tough chewy egg into smaller constituent parts. This resistance during chewing is similar to the tough chewy nature of beef jerky.

Raw egg white (before transitioning to the solidified state and then the tough and chewy state) contains eight parts of water to one part of egg solids. The tough chewy state exists when the water to egg ratio is between one part egg to one part water and four parts egg to one part of water. Prior to cooking food dye is added to the mix to achieve a brown color similar to beef jerky. After cooking, the egg jerky is sprinkled with a seasoning mixture of cheese powder, hickory bacon salt powder, and chipotle chili pepper powder to achieve a spicy barbeque flavor. (Alternately, the seasonings can be added to the raw mix before cooking.) Immediately after cooking and seasoning, the seasoned egg jerky is packed in a high oxygen barrier bag along with an oxygen absorbent pouch such as powdered iron or iron salts to prevent growth of aerobic microorganisms such as fungus. (If the egg sits in low moisture air, it will transition to a crunchy state.) Egg packaged in this way has a shelf life of at least several months. Experimentation with bagging egg jerky in a plastic bag and no oxygen absorbent confirms that microbial growth such as fungus is prolific on the egg with the main constraint on microbial growth being access to oxygen. Bagged in a way where oxygen is accessible in the bag or through the bag results in a minimal product shelf life. In this scenario, the product is refrigerated or frozen to constrain microbial growth.

### Soft Tortilla Product Embodiment

Soft tortillas were produced that were similar to the third cooked egg state described above. For example one teaspoon of canola oil was placed in a cup sized mixing bowl. Two to teaspoons powdered egg was added and gently stirred until the egg melted into the oil. Eight teaspoons of liquid egg white was added along with a teaspoon of gelatin and a teaspoon of dried butter milk. This mixture was gently stirred until consistent. A four inch diameter circle 1/16^{th} deep of the batter was placed on a ten inch diameter plate, then microwaved for 30 to 45 seconds. The resulting 6 inch soft flexible tortilla is suitable for wrapping around meats and vegetables in a customary handheld sandwich wrap and for other uses for which one uses flexible wheat based tortillas. As described above, it can be packed for low oxygen or refrigerated or frozen so as to retain its moisture while constraining microorganism growth. The product is low in carbohydrates and high in protein.

Similar 6 inch soft tortillas were toasted in a toaster for 60 seconds to produce a nice crisp golden brown exterior while maintaining a soft interior.

### Bread Product Embodiment

An aerated soft bread like product was produced using the third cooked egg state described above. One teaspoon of canola oil was placed in a cup sized mixing bowl, added were two teaspoons powdered egg, six teaspoons of liquid egg white was added along with a teaspoon of gelatin and a teaspoon of dried butter milk. This mixture was whip to be heavily aerated. Two teaspoons were added to a batch of three inch dishes and then microwaved for forty five seconds. The result being an airy product having characteristics of the third cooked egg state. The product is an aerated version of the flour tortilla that can be utilized similarly to bread. As described, it can be packed for low oxygen or refrigerated or frozen so as to retain its moisture while constraining microorganism growth. The product is low in carbohydrates and high in protein.

### Layered Product Embodiment

One teaspoon of canola oil was placed in a cup sized mixing bowl, added were two teaspoons powdered egg, six teaspoons of liquid egg white was added along with a teaspoon of gelatin. Half a teaspoon of batter was placed in each of two bowls and cooked for 45 seconds until solidified.

One teaspoon of canola oil was placed in a cup sized mixing bowl, added were two teaspoons powdered egg, six teaspoons of liquid egg white was added along with a teaspoon of dried butter milk. Half a teaspoon of batter was placed in a bowl and cooked for 45 seconds until solidified.

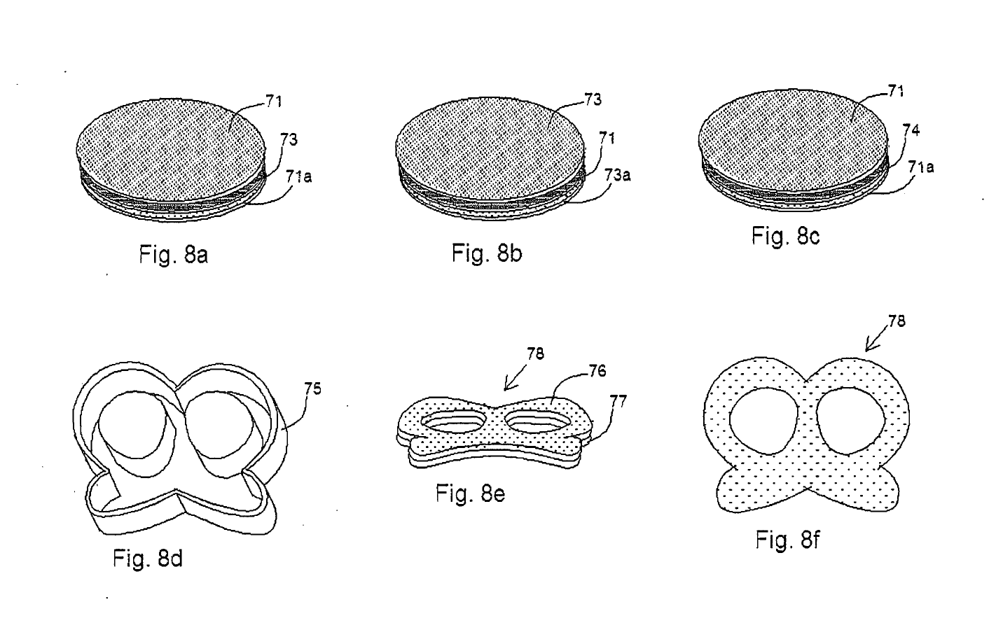

A layer of solidified batter including gelatin was placed on the bottom, a layer of solidified batter including butter milk batter was placed in the middle and a layer of solidified batter containing gelatin was placed on the top. The stack was cooked until the outside was crisp. The final product was the first crunchy egg layered chip illustrated in FIG. 8a including a top crunchy chip 71 containing gelatin affixed to a middle crunchy layer 73 containing buttermilk which is affixed to a bottom crunch chip 71a containing gelatin. Thus a crunchy chip was fabricated by combining 3 solidified layers then crisping them together in the microwave where they become affixed to one another.

A crunchy layered chip was also fabricated by combining 3 solidified layers then crisping them together in the microwave where they become affixed to one another. A layer made of solidified butter milk batter was placed on the bottom, a layer made of solidified gelatin batter was placed in the middle, and a layer made of solidified buttermilk batter was placed on the top.

A product was made using the above ingredients wherein the final product was the first crunchy egg layered chip illustrated in FIG. 8c including a top crunchy chip 71 (state 2) containing gelatin affixed to a middle chewy layer 74 (state 3) containing buttermilk which is affixed to a bottom crunch chip 71a containing gelatin.

FIG. 8b illustrates second crunchy egg layered chip.

FIG. 8c illustrates third crunchy egg layered chip.

Raw batter can be poured into the pretzel shaped mold FIG. 8d in the following order. A layer of raw batter including gelatin was placed on the bottom, a layer of raw batter including butter milk was placed in the middle and a layer of raw batter containing gelatin was placed on the top. The stack was cooked until crispy. The final product is a pretzel shaped chip that has hard outer shells on the top and bottom and a more crumbly interior.

FIG. 8e illustrates a layered pretzel shaped egg chip including a first layer 75 and a second layer 77. Each layer has different properties such as taste or crunchiness. Layers are poured atop one another as raw batter and cooked together to be affixed to one another.

FIG. 8f is a top view of the layered pretzel shaped egg chip 78.

### Translucent Chip Product Embodiment

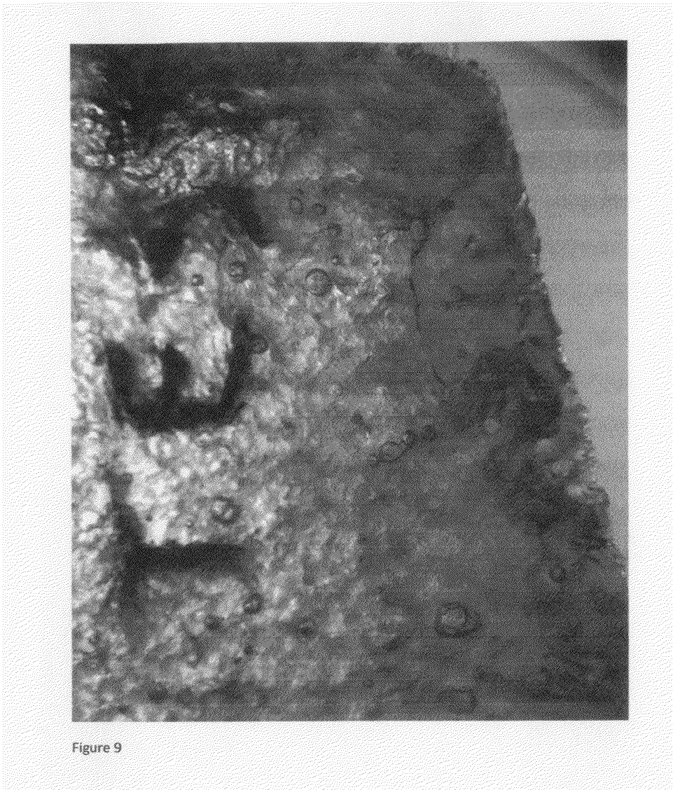

One teaspoon of canola oil was placed in a cup sized mixing bowl, added was teaspoon powdered egg, two tablespoons of water along with a teaspoon of gelatin. This batter was allowed to sit for sixty minutes to allow the gelatin and the egg to absorb water. The result is a thick batter. Half a teaspoon was placed into a dish and cooked for ninety seconds. The result is a solid non-pores crispy translucent chip. At least 50% of light incident upon the chip passes through it. FIG. 9 is a 10× image of light passing through the translucent egg chip. The word “TEST” was written on transparent plastic and placed against the bottom of the chip. The word can easily be read through the chip with the human eye. The image in FIG. 9 shows that the word “TEST” can be read through the chip. Thus a translucent chip was produced that allows 50% of light to pass therethrough and also quarter inch letters can be read threrethrough when lit from underneath.

### Operation of the Invention

Operation of the invention has been discussed under the above under the Detailed Description of the Invention heading and is not repeated here to avoid redundancy.

### CONCLUSION, RAMIFICATIONS, AND SCOPE

Thus the reader will see that the crunchy egg product, manufacturing apparatus, and manufacturing processes of this invention provides a well defined and desirable consumer product that is nutritious and fulfills a gap in crunchy low carbohydrate snack food product category. While the above description describes many specifications, these should not be construed as limitations on the scope of the invention, but rather as an exemplification of a preferred embodiment thereof. Many other variations are possible.

The egg ingredient herein can comprise whole egg or any egg product derived there from including glucose reduced dried egg or glucose reduced dried egg white.

It should be noted that the phrase “raw egg batter” is used herein to distinguish between the batter, solidified egg, and crisped egg. In fact the egg portion of the batter may consist of only dried egg or dried egg white in which case no literal raw egg is utilized.

Raw egg deposition or batter deposition means placing the batter into a position for cooking for example; depositing batter onto a surface, extruding batter onto a surface, depositing batter into a flyer, extruding batter into a flyer, and extruding batter into air that is then heated or microwaved.

The term solidifying is used herein to mean transitioning of the batter from a liquid or foam state to a high moisture content solid state, solidifying is a cooking process.

The term crisping is used here to mean transitioning of the solidified egg into a low moisture crunchy product. Crisping is a cooking process and/or a drying process.

Ingredients are mixed together herein, whipping is a specialized form of mixing that may for example mean mixing air or other gases into the raw egg or the batter to achieve certain properties suitable for the crunchy puffed egg product for example.

Spraying onto the solidified egg is described as a color, flavoring, texture, or oil additive step. Other additive steps are possible such as sprinkling onto the solidified egg, and tumbling the solidified egg in a bath of dried or moist flavorings. Similarly the batter can receive additives through spraying, sprinkling, and tumbling and the crisped egg can receive additives through spraying, sprinkling, and tumbling.

Microwaving was specified as a cooking process to transition egg from a raw batter state to a solidified state. It should be noted that other cooking methods such as baking and frying can be substituted. Microwaving was specified as a cooking process to transition egg from a solidified state to a crispy state. It should be noted that other cooking methods such as baking and frying can be substituted. Microwaving was specified as a cooking process to transition egg from a solidified state to a tough and chewy state. It should be noted that other cooking methods such as baking and flying can be substituted. Microwaving was specified as a drying method to remove moisture from an egg based batter. It should be noted that drying method such as dry air and baking can be substituted.

What is claimed:

1. A crunchy egg product comprising;
egg,
wherein said egg undergoes a cooking process,
wherein by volume said final crunchy egg product contains more than thirty percent egg, wherein by weight said final crunchy egg product contains less than ten percent water wherein said crunchy egg product has a crunchy attribute that is characterized by one selected from the group consisting of; when said crunchy egg product is fractured an audible cracking sound is produced, and when said crunchy egg product is subjected to a three point bend test it fractures after bending ten degrees or less.

2. The crunchy egg product of claim 1 wherein said, when said crunchy egg product is fractured an audible cracking sound is produced, attribute is selected and wherein when said crunchy egg product is subjected to a three point bend test it fractures after bending ten degrees or less.

3. The crunchy egg product of claim 1 wherein a single unit of said crunchy egg product is suitable in size for grasping and holding with fingers during consumption.

4. The crunchy egg product of claim 1 wherein prior to cooking said egg comprises a water reduced egg product.

5. The crunchy egg product of claim 1 wherein prior to cooking said egg comprises dried egg.

6. The crunchy egg product of claim 1 wherein said crunchy egg product further comprises at least one ingredient selected from the group consisting of whole egg, egg white, dried egg, dried egg white, water, air, coloring, onion, garlic, salt, pepper, cheese, taco flavoring, barbecue flavoring, milk, oil, fat, shortening, yeast, and baking power.

7. The crunchy egg product of claim 6 wherein said ingredient is added at a time selected from the group consisting of; added to be part of a mixture prior to cooking, added after a solidification step, and added after a crisping step.

8. The crunchy egg product of claim 6 wherein said ingredient is incorporated into the product by a process selected from the group consisting of; mixing, whipping, spraying, sprinkling, and tumbling.

9. The crunchy egg product of claim 1 wherein said cooking process comprises one selected from the group consisting of microwaving, frying, and baking.

10. The crunchy egg product of claim 1 wherein a drying process is performed and in a sequence selected from the group consisting of; said cooking process is first performed then said drying process, said drying process is first performed then said cooking process, and said cooking and said drying processes are performed concurrently.

11. The crunchy egg product of claim 1 wherein said product first undergoes a solidification step, then a cutting step, then a drying step.

12. The crunchy egg product of claim 1 wherein prior to cooking said egg is extruded to produce a desired product shape characteristic.

13. The crunchy egg product of claim 1 wherein said cooking occurs in a mold to produce a desired product shape characteristic.

14. The crunchy egg product of claim 1 wherein prior to cooking said egg is poured to produce a desired product shape characteristic.

15. The crunchy egg product of claim 1 wherein its manufacturing process comprises the steps of;
Providing cookware,
Oiling said cookware,
Deposition of ingredients onto cookware,
Solidification,
Cutting,
and drying.

16. The crunchy egg product of claim 1 wherein a fracture consists of one selected from the group consisting of a crack that penetrates through the thickness of said product, and a crack that penetrates the surface of said product.
